(19) United States
(12) Patent Application Publication
(10) Pub. No.: US 2024/0154156 A1
(43) Pub. Date: May 9, 2024

(54) ELECTRODE FOR ALL-SOLID-STATE LITHIUM SULFUR ELECTROCHEMICAL ELEMENT COMPRISING IONICALLY AND ELECTRONICALLY CONDUCTIVE SULFIDE ELECTROLYTE

(71) Applicant: SAFT, LEVALLOIS PERRET (FR)

(72) Inventors: Christian JORDY, PAREMPUYRE (FR); Florent FISCHER, BRUGES (FR)

(73) Assignee: SAFT, LEVALLOIS PERRET (FR)

(21) Appl. No.: 18/281,430

(22) PCT Filed: Mar. 10, 2022
(86) PCT No.: PCT/EP2022/056257

§ 371 Date: Sep. 11, 2023

(30) Foreign Application Priority Data
Mar. 11, 2021 (FR) FR2102389

(51) Int. Cl. H01M 10/0562; H01M 4/02; H01M 4/133; H01M 4/58; H01M 4/587; H01M 10/052

(52) U.S. Cl. CPC H01M 10/0562; H01M 4/133; H01M 4/5815; H01M 4/587; H01M 10/052; H01M 2004/021; H01M 2004/028; H01M 2300/008

(57) ABSTRACT

The present invention relates to an active material for positive electrode, suitable for solid-state lithium sulfide electrochemical elements, comprising an ionically conductive and electronically conductive electrolyte, and to electrochemical elements comprising same.

### CROSS REFERENCE TO RELATED APPLICATIONS

The present application is a U.S. National Phase Application under 35 U.S.C. § 371 of International Patent Application No. PCT/EP2022/056257 filed Mar. 10, 2023, which claims priority of French Patent Application No. 21 02389 filed Mar. 11, 2021. The entire contents of which are hereby incorporated by reference.

### FIELD OF THE INVENTION

The present invention relates to lithium batteries and in particular lithium-sulfur (Li/S) batteries.

### BACKGROUND

Such batteries are a possible alternative to conventional lithium-ion (Li-ion) batteries used for energy storage. Sulfur is used as an active material in positive electrodes, according to the overall reaction:

2Li+S−>Li₂S

with a difference of voltage of 2 V.

Due to the high theoretical mass energy density, the natural abundance and the low toxicity thereof, sulfur is a promising material. However, at present, sulfur-based positive electrodes have low performance due to the low electronic conductivity of sulfur. Thereby, a conductive material such as carbon can be incorporated into the sulfur, for improving the electronic conductivity. Li—S batteries can be of the liquid (liquid electrolyte) batteries or the solid (solid electrolyte) batteries. Solid electrolytes have many advantages, in particular in terms of safety.

Solid sulfide electrolytes are not thermodynamically stable at potentials above 2.5V. The use of sulfide electrolytes is made possible at high potentials due to the formation of an electronically insulating and ionically conducting [solid electrolyte] interface (SEI) layer. Such insulating layer will prevent the electrolyte which has not reacted from reaching high electrical potentials and thereby avoiding a massive decomposition of the electrolyte. However, the electronically insulating layer inhibits the conduction of current by means of the electrolyte within the electrode. Consequently, solid sulfide electrolytes are a priori not suitable for such electrodes.

U.S. Pat. No. 9,337,509 describes solid electrolytes the particles of which are at least partially coated with a layer of carbon. However, since carbon is not an ionic conductor, such coating can degrade the ionic conductivity of solid electrolytes. In addition, the coating involves an additional preparation step.

EP 3 012 887 describes a positive electrode material for a solid-state Li—S battery, comprising in particular sulfur, carbon and a phosphorus-based ion conducting material the electrical conductivity of which is measured by impedance, without however considering the electronic conductivity of the ionically conducting material.

It is thus desirable to provide improved solid sulfide electrolytes suitable for Li—S batteries.

### SUMMARY

According to the invention, such aim is achieved in particular by ionically and electronically conductive electrolytes in sulfur-containing positive electrodes the working potentials of which are close to the thermodynamic stability range of the electrolyte.

The electrodes according to the invention thus lead to a better functioning of the active sulfur and to a reduction in the content of carbon, the quantity of which used today is high due to the very low electronic conductivity of the sulfur.

According to a first subject matter, the present invention therefore relates to a positive electrode for an all-solid lithium sulfur electrochemical cell, comprising a current collector and an electrode material, said electrode material comprising sulfur, carbon and a solid sulfide electrolyte,
said electrode being characterized in that the solid sulfide electrolyte has an electronic conductivity greater than 10⁻¹⁰ S/cm, preferentially greater than 10⁻⁸ S/cm, in particular greater than 10⁻⁶ S/cm.

According to a particular subject matter, the present invention further relates to a positive electrode for a solid-state lithium sulfur electrochemical cell, comprising a current collector and an electrode material, said electrode material comprising sulfur, carbon particles and a solid sulfide electrolyte,
the solid electrolyte particles being, if appropriate, at least partially coated with a layer of carbon,
said electrode being characterized in that the solid sulfide electrolyte has an electronic conductivity greater than 10⁻¹⁰ S/cm, preferentially greater than 10⁻⁸ S/cm, in particular greater than 10⁻⁶ S/cm, and
such that said positive electrode comprises less than 5% by weight of carbon, with respect to the total weight of the electrode material.

The term “positive electrode” refers to the electrode where the electrons enter, and where the cations (Li+) arrive during the discharge process. The term “positive electrode” thus refers, when the battery is in discharge, to the electrode working as an anode and, when the battery is in charge, to the electrode working as a cathode, the anode being defined as the electrode where an electrochemical oxidation reaction (electron emission) takes place, whereas the cathode is the seat of the reduction.

The positive electrode generally consists of a conductive support used as a current collector, coated with at least one layer comprising the electrode material.

Said electrode material is also called active material.

The electrode layer can further comprise, in addition to the electrode material, solid electrolyte particles and a binder.

The current collector is preferentially a two-dimensional conductive support such as a pad, a plate, an either solid or perforated strip, containing a conductor material such as a metal, e.g. copper, nickel, steel, stainless steel or aluminum, providing the conduction of the electron flow between the electrode and the terminals of the battery. The current collector of the positive electrode layer is typically made of aluminum.

“Binder” refers to materials which can impart to the electrode the cohesion of the different components and the mechanical strength thereof on the current collector, and/or to impart a certain flexibility to the electrode for the use thereof in a cell. The binders include polyvinylidene fluoride (PVDF) and the copolymers thereof, polytetrafluoroethylene (PTFE) and the copolymers thereof, polyacrylonitrile (PAN), poly(methyl)- or (butyl)methacrylate, polyvinyl chloride (PVC), poly(vinyl formal), polyester, block polyetheramides, acrylic acid polymers, methacrylic acid, acrylamide, itaconic acid, sulfonic acid, elastomer and cellulosic compounds. The elastomer or elastomers which can be used as a binder can be selected from styrene-butadiene (SBR), butadiene-acrylonitrile (NBR), hydrogenated butadiene-acrylonitrile (HNBR), and a mixture of a plurality thereof.

Typically, carbon is distributed, in the form of particles, across the electrode layer so as to form an electron percolating network between all the particles of active material and the current collector.

“Electrochemical cell” refers to an elementary electrochemical cell consisting of the positive electrode/electrolyte/negative electrode assembly, making it possible to store the electrical energy supplied by a chemical reaction and to restore the energy in the form of a current.

A lithium sulfur electrochemical cell is an element wherein, in the charged state, the negative electrode contains metallic lithium, and the positive electrode contains sulfur. Upon discharge of the battery, the metallic lithium is oxidized to Li+ ion on the surface of the negative electrode, and during the charge, the Li+ ion is reduced to the metallic state on the negative electrode.

A “solid-state” element refers to an element for which the electrolyte is in the solid state, such as an oxide, a sulfide or a polymer. In solid-state elements, and according to the invention, the positive electrode layer comprises electrolytic particles. The same can apply to the negative electrode layer.

According to one embodiment, the solid electrolyte of the separation layer is identical to or different from the solid electrolyte present in the positive electrode.

According to the invention, the electrolyte is a solid sulfide electrolyte.

Sulfur solid electrolytes include in particular sulfur-containing compounds alone or mixed with other constituents, such as polymers or gels.

Examples of sulfide electrolytic compositions are described in particular in Park, K. H., Bai, Q., Kim, D. H., Oh, D. Y., Zhu, Y., Mo, Y., & Jung, Y. S. (2018). Design Strategies, Practical Considerations, and New Solution Processes of Solid Sulfide Electrolytes for All-Solid-State Batteries. Advanced Energy Materials, 1800035.

Either partially or fully crystallized sulfides as well as amorphous solids, are included. Examples of such materials can be selected from sulfides with the composition A Li₂S— B P₂S₅ (with 0<A<1.0<B<1 and A+B=1) and the derivatives thereof (e.g. with Lil, LiBr, LiCI, etc. doping); sulfides with argyrodite structure; or having a crystallographic structure similar to the compound LGPS (Li₁₀GEP₂S₁₂), and the derivatives thereof. Electrolytic materials can also include oxysulfides, oxides (garnet, phosphate, anti-perovskite, etc.), hydrides, polymers, gels or ionic liquids conducting lithium ions.

According to one embodiment, said electrolyte present in the positive electrode layer contains one or a plurality of transition metals, preferentially selected from Ti, V, Mo, W, Fe Bi, Ni, Co. Typically, said electrolyte is doped with such a transition metal.

According to one embodiment, said electrolyte present in the positive electrode layer is chosen from electrolytes with the formula (I):

(Li₂S)ₓ(P₂S₅)_{y}(LiHal)_{z}(M1 Sn)ₜ(M2Sp)ᵤ (I)
Hal represents a halogen atom selected from CI, I, Br;
M1 represents an atom selected from Si, B, GE, Al, Sn, In;
M2 represents a transition metal, preferentially selected from Ti, V, Mo, W, Fe, Bi, Ni, Co;
n and p, either identical or different, are numbers between 0.5 and 3;
x is a number between 0.3 and 0.8;
y is a number between 0.1 and 0.5;
z is a number between 0 and 0.4;
t is a number between 0 and 0.5;
u is a number between 0 and 0.2;
such that x+y+z+t+u=1.

According to one embodiment, said electrolyte present in the positive electrode layer is a solid sulfide electrolyte as defined hereinabove, the particles of which are at least partially coated with a layer of carbon, preferentially with a thickness comprised between 1 and 10 nm.

The term “electronic conductivity” refers to the aptitude of a material to let electrons move freely and thus let an electric current flow through.

Electronic conductivity differs from ionic conductivity, which relates to the circulation of ions (see hereinafter). Electronic conductivity and ionic conductivity are two components of the electrical conductivity of an electrolyte.

Electronic conductivity is typically measured with a conductivity meter. Same can be expressed in macm⁻¹, or S/cm, but is expressed in S.rn⁻¹ in the international system.

According to the invention, the electronic conductivity of the sulfide electrolyte is greater than 10⁻¹⁰ S/cm, preferentially greater than 10⁻⁸ S/cm, in particular greater than 10⁻⁶ S/cm.

The electronic conductivity can thereby be measured by imposing a direct current I between the 2 faces of an electrolyte pellet of surface area S and thickness e, placed between 2 blocking electrodes. The value of the electronic conductivity is estimated from the ratio (e*I) /(dV*S) where dV is the voltage difference measured between the faces of the pellet.

The measurement of the electronic conductivity is typically carried out at ambient temperature. The electronic conductivities mentioned are given at room temperature.

Preferentially, the positive electrode is suitable for a potential range between 1 and 2.7 V.

According to one embodiment, the positive electrode according to the invention comprises less than 20% by weight of carbon, preferentially less than 5% by weight, with respect to the total weight of the material of the electrode.

The percentage refers to the total carbon present in the material of the electrode, in the form of carbon particles within the material of the electrode and, if appropriate, in the form of a coating of the electrolyte particles.

According to one embodiment, said solid sulfide electrolyte has an ionic conductivity greater than 1 mS/cm.

The term “ionic conductivity” refers to the aptitude of a material to let ions move freely and thus let an alternating electric current flow through.

The ionic conductivity can be measured by impedance spectroscopy by imposing an alternating current I between the 2 faces of an electrolyte pellet of surface area S and thickness e, placed between 2 blocking electrodes. The value of the ionic conductivity σl is estimated from the relation:

σionic=σelectrical−σelectronic with σelectrical=e/(R*S)

where electronic is the electronic conductivity of the pellet and R is the resistance measured on the Nyquist diagram corresponding to the intersection of the signal relating to the blocking electrodes with the real axis.

According to the invention, the ionic conductivity of the solid electrolyte is thus greater than 1 mS/cm.

The ionic conductivity is typically measured at room temperature. The ion conductivities mentioned are given at room temperature.

According to one embodiment, the solid sulfide electrolyte has an electronic conductivity greater than 10⁻¹⁰ S/cm, preferentially greater than 10⁻⁸ S/cm, in particular greater than 10⁻⁶ S/cm, and an ionic conductivity greater than 1 mS/cm, at room temperature.

According to one embodiment, the carbon is present in the positive electrode layer in the form of nanofibers (CNF) or nanotubes (CNT), with a diameter of less than 100 nm, preferentially less than 30 nm.

The term “carbon nanofiber” or ONE used herein refers to cylindrical structures composed of carbon. The nanofibers are of nanornetric size and typically have a diameter comprised between 10 and 80 nanometers.

“Carbon nanotubes” refer to an allotropic form of carbon belonging to the fullerene family. Same are typically composed of one or a plurality of layers (SWNT or SWCNT, for Single-Wailed (Carbon) Nanotubes. or MWNT or MWCNT. for Multi-Wailed (Carbon) Nanotubes) of carbon atoms, rolled in around themselves forming a tube.

According to one embodiment, the positive electrode comprises carbon nanoparticles with a diameter of less than 20 nm.

According to one embodiment, the sulfur present in the positive electrode layer is in the form of elemental sulfur. Preferentially, the sulfur particles have a diameter of less than 200 nm.

According to another subject matter, the invention further relates to a solid-state electrochemical element comprising a positive according to the invention.

The electrochemical cell comprises
A positive electrode according to the invention;
A lithium negative electrode;
A layer of solid sulfide electrolyte separating the two electrodes.

The solid electrolyte particles present in the separation layer can be either identical or different from the electrolyte particles present in the electrodes.

According to one embodiment, the electrolyte in the separation layer is different from the electrolyte present in the positive electrode.

The electrochemical cell is suitable for energy storage, in particular in mobile, stationary (e.g. for storing renewable energy), space, in particular aeronautical, devices.

The negative electrode consists of a conductive support used as a current collector, as defined hereinabove, coated with a layer of material containing in particular lithium in metal state; the layer can contain solid electrolyte and possibly carbon. The current collector can also be made of a material containing metallic lithium.

Said collector with the negative electrode is generally in the form of a copper strip.

According to one embodiment, said negative electrode layer can also contain a binder, such as the binders mentioned hereinabove for the positive electrode.

An element according to the invention can be prepared by the following method:
a) preparation of a powder pellet of the solid electrolyte of the separation layer (either identical or different from the solid electrolyte present in the positive electrode), e.g. by compression, typically at more than 200 MPa;
b) bringing the pellet in contact with a powder the material of the positive electrode including sulfur, carbon and solid electrolyte, and adding a current collector, such as an aluminum layer, in contact with the cathode active material;
c) compression of the assembly, typically at more than 200 MPa,
d) bringing in contact a free surface of the pellet during the step a) with a lithium-based negative electrode,
e) compression of the assembly, typically at more than 10 MPa.

According to another subject matter, the invention further relates to an electrochemical module comprising a stack of at least two elements according to the invention, every element being electrically connected with one or a plurality of other elements, in particular via the current collectors thereof.

According to another subject matter, the present invention further relates to a battery comprising one or a plurality of modules according to the invention.

“Battery” refers to the assembly of a plurality of modules.

Said assemblies can be in series and/or parallel.

### BRIEF DESCRIPTION OF THE DRAWING

FIG. 1 is a schematic representation of the electrochemical element according to the invention.

### DETAILED DESCRIPTION

The element comprises a positive electrode (8) according to the invention, a negative electrode (10), separated by an electrolytic layer (9).

The positive electrode layer (8) comprises a current collector (1) on which the negative electrode material layer according to the invention is deposited, consisting of solid electrolyte particles (3), of sulfur particles (4) and of carbon particles (fibers or nanotubes) (2).

The separation layer (9) consists of solid electrolyte particles (5) and is not electron conductive. The particles (5) are different from the particles (3).

The negative electrode (10) comprises a current collector (7) on which lithium metal or a lithium-based alloy (6) is deposited.

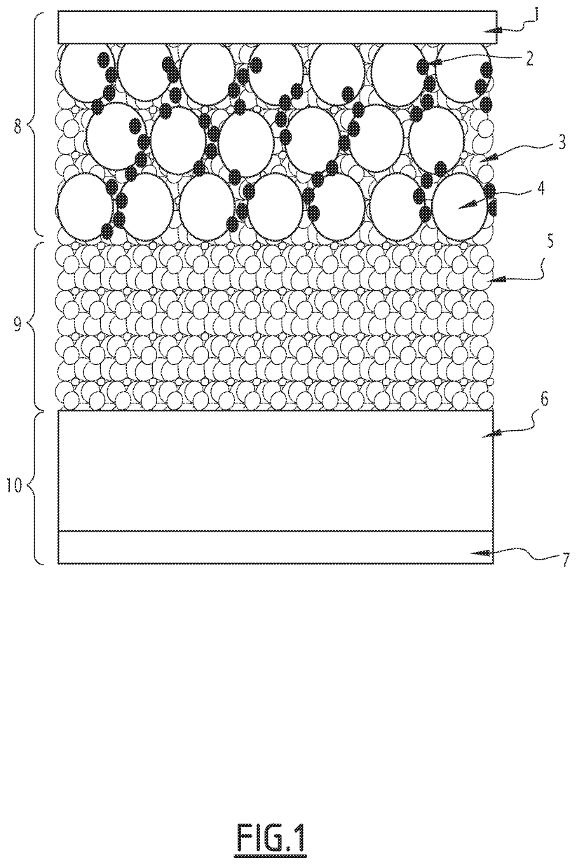

It is understood that the constituent layers of the element (8) and (5) can further comprise, binders, which are not shown in FIG. 1.

The solid electrolyte particles (3) are sulfides having an electronic conductivity as described according to the invention.

### EXAMPLES

### Preparation of Electrolyte Materials

The compound Li₆P_{0.98}Ti_{0.02}S_{4.99}(Cl_{0.5}I_{0.5}) was synthesized in the following way:

The precursors used are powders of Li₂S, P₂S₅, LiCI, Lil of metallic titanium and of sulfur. The precursors are introduced in stoichiometric quantities with zirconia beads into a sealed zirconia jar in a glove box under argon. The jars are then placed in a Fritsch Pulverisette® P7 planetary mill. The mixture is ground for 24 h at a speed of 800 rpm. After the mechanosynthesis step, the powder is heat-treated under argon between 100 and 500° C., e.g. at 200° C.

A pellet of the material is produced by compressing the powder in a matrix under a pressure of 400 MPa.

The electronic conductivity of such material can be measured by imposing a direct current I between the 2 faces of the electrolyte pellet of surface area S and thickness e, placed between 2 blocking electrodes. The value of the electronic conductivity is estimated from the ratio (e*I)/(dV*S) where dV is the voltage difference measured between the faces of the pellet.

The electronic conductivity of the material is estimated at 10⁻⁸ S/cm at room temperature.

The ionic conductivity can be measured by impedance spectroscopy by imposing an alternating current I between the 2 faces of an electrolyte pellet of surface area S and thickness e, placed between 2 stainless steel electrodes. The value of the ionic conductivity σ is estimated from the relation:

σ_{ionic}=σ_{electrical}−σ_{electron} Withσ_{electrical}=e/(R*S)

where σ_{electron} is the electronic conductivity of the pellet and R is the resistance measured on the Nyquist diagram corresponding to the intersection of the signal relating to the blocking electrodes with the real axis.

The ionic conductivity is estimated to be about 1 mS/cm at room temperature.

Preparing the Accumulators:

Under argon or under dry atmosphere, the carbon powder is dispersed in xylene using an ultrasonic mixer, for properly deagglomerating the particles, more particularly for carbon nanofibers or nanotubes. Sulfur and solid electrolyte are then fed into the suspension. The homogenization of the mixture can also be carried out by ultrasound or using a paddle mixer. The mixture is dried under vacuum and then introduced into a Fritsch Pulverisette P7 planetary mill. The mixture is then compressed at 300 MPa in a stainless-steel matrix on an aluminum strip.

The electrolyte layer acting as separator is prepared by compressing powder of composition Li 6 PS 5 Cl in a matrix under a pressure of 300 MPa. The final accumulator is then obtained by compressing the positive electrode on the electrolyte layer at 400 MPa and then compressing a lithium metal film on the other side of the electrolyte layer at a pressure of 100 MPa.

The interest of the invention can be illustrated by the following models:

The table shows the impact of carbon content, of the carbon fiber size and of the electronic conductivity on polarization at a level of 0.2C and on the volume capacity of the electrode at a level of C/50

The models are based on the assumption that the fibers are distributed perfectly homogeneously and that each fiber is at the potential of the electrode.

TABLE 1

| | | | | | | polarization due to | |
|---|---|---|---|---|---|---|---|
| | | | | C fiber | electronic | electronic | |
| | | | | diameter | conduct. | conduction (mV) | mAh/cc |
| No. | % m C | % m ES | % m S | (μm) | (S/cm) | at 0.2 C | at C/50 |
| 1 | 40 | 30 | 30 | 0.5 | 1.00E−09 | 36.7 | 840 |
| 2 | 30 | 30 | 40 | 0.5 | 1.00E−09 | 80.9 | 1120 |
| 3 | 20 | 30 | 50 | 0.5 | 1.00E−09 | 200.4 | 1400 |
| 4 | 10 | 30 | 60 | 0.5 | 1.00E−09 | 727.8 | 1680 |
| 5 | 5 | 30 | 65 | 0.5 | 1.00E−09 | >1 V | 1820 |
| 6 | 3 | 30 | 67 | 0.5 | 1.00E−09 | >1 V | 1876 |
| 7 | 1 | 30 | 69 | 0.5 | 1.00E−09 | >1 V | 1932 |
| 8 | 3 | 30 | 67 | 0.5 | 1.00E−08 | 468.6 | 1876 |
| 9 | 3 | 30 | 67 | 0.2 | 1.00E−08 | 75.0 | 1876 |
| 10 | 3 | 30 | 67 | 0.1 | 1.00E−08 | 18.7 | 1876 |
| 11 | 3 | 30 | 67 | 0.01 | 1.00E−08 | 0.2 | 1876 |
| 12 | 3 | 30 | 67 | 0.05 | 1.00E−08 | >1 V | 1876 |
| 13 | 3 | 30 | 67 | 0.1 | 1.00E−11 | >1 V | 1876 |
| 14 | 3 | 30 | 67 | 0.1 | 1.00E−10 | >1 V | 1876 |
| 15 | 3 | 30 | 67 | 0.1 | 1.00E−09 | 187.4 | 1876 |
| 16 | 3 | 30 | 67 | 0.1 | 1.00E−08 | 18.7 | 1876 |
| 17 | 3 | 30 | 67 | 0.1 | 1.00E−07 | 1.9 | 1876 |
| 18 | 3 | 30 | 67 | 0.1 | 1.00E−06 | 0.2 | 1876 |
| 19 | 1 | 80 | 19 | 0.1 | 1.00E−05 | 0.0 | 532 |

Where % mC, % mES, % m S represent the percentage by weight of carbon, solid electrolyte and sulfur within the positive electrode, respectively, with respect to the weight of the layer of electrode material.

The following conclusions emerge from the calculations:

For an electronic conductivity of the electrolyte of 10⁻⁹ S/cm, below 10% carbon in the cathode, the polarization due to the electronic conductivity is greater than 1V at a level of C/5, which is insufficient for the use of the accumulators for the envisaged applications, and above 30% carbon, the capacity becomes less than 1000 mAh/cc, which is unfavorable for applications requiring very high energy densities.

At low carbon content (3%), using 0.1 μm (or 100 nm) carbon fibers, the volume capacity is very high (>1800 mAh/cc) but the polarization due to the electron conduction in the electrode is greater than 1V at C/5 while the electronic conductivity of the cathode electrolyte is less than 10⁻¹⁰ S/cm. Therefore, the power delivered by the battery is highly insufficient. On the other hand, for higher conductivities, the polarization becomes less than 200 mV at C/5, which is suitable for the envisaged applications.

Still at low carbon content, the use of nanofibers of very small size also has a significant role on polarization. Indeed, for an electrolyte the electronic conductivity of which is 10⁻⁸ S/cm, the polarization for a carbon fiber content of 3% is less than 200 mV when the size of the fibers is less than 200 nm.

1. A positive electrode for a solid-state lithium sulfur electrochemical cell, comprising a current collector and an electrode material, said electrode material comprising sulfur, carbon particles and a solid sulfide electrolyte,
wherein the solid sulfide electrolyte has an electronic conductivity greater than 10⁻¹⁰ S/cm.

2. The electrode according to claim 1, the formulation comprising less than 20% by weight of carbon, preferentially less than 5% by weight, with respect to the total weight of the material of the electrode.

3. The electrode according to claim 1, wherein said solid sulfide electrolyte has an ionic conductivity greater than 1 mS/cm.

4. The electrode according to claim 1, such that the carbon is present in the form of nanotubes or nanofibers with a diameter of less than 100 nm, preferentially less than 30 nm.

5. The electrode according to claim 4, wherein the carbon particles have a diameter of less than 20 nm.

6. The electrode according to claim 1, wherein said electrolyte contains one or a plurality of transition metals, preferentially selected from Ti, V, Mo, W, Fe Bi, Ni, Co.

7. The electrode according to claim 1, wherein said electrolyte is selected from the electrolytes with the formula (I):
(Li₂S)ₓ(P₂S₅)_{y}(LiHal)_{z}(M1 Sn)ₜ(M2Sp)ᵤ (I)
Hal represents a halogen atom selected from Cl, I, Br;
M1 represents an atom selected from Si, B, GE, Al, Sn, In;
M2 represents a transition metal, preferentially selected from Ti, V, Mo, W, Fe, Bi, Ni, Co;
n and p, either identical or different, are numbers between 0.5 and 3;
x is a number between 0.3 and 0.8;
y is a number between 0.1 and 0.5;
z is a number between 0 and 0.4;
t is a number between 0 and 0.5;
u is a number between 0 and 0.2;
such that x+y+z+t+u=1.

8. The electrode according to claim 1, wherein said electrolyte is a solid sulfide electrolyte, the particles of which are at least partially coated with a layer of carbon, preferentially with a thickness comprised between 1 and 10 nm.

9. The electrode according to claim 1 such that the sulfur particles have a diameter of less than 200 nm.

10. A solid-state electrochemical element comprising a positive electrode according to claim 1.

11. A solid-state electrochemical element according to claim 10, consisting of a negative electrode, a positive electrode and an electrolytic separation layer, such that the electrolyte of the separation layer is different from the electrolyte present in the positive electrode.

12. An electrochemical module comprising a stack of at least two elements according to claim 10, each element being electrically connected with one or a plurality of other elements.

13. A battery comprising one or a plurality of modules according to claim 12.

14. An electrochemical module comprising a stack of at least two elements according to claim 11, each element being electrically connected with one or a plurality of other elements.

15. The electrode according to claim 1, wherein the solid sulfide electrolyte has an electronic conductivity greater than 10⁻⁸ S/cm.

16. The electrode according to claim 1, wherein the solid sulfide electrolyte has an electronic conductivity greater than 10⁻⁶ S/cm.
